(19) United States
(12) Patent Application Publication
(10) Pub. No.: US 2013/0272163 A1
(43) Pub. Date: Oct. 17, 2013

(54) NON-SEAMLESS OFFLOAD INDICATOR

(71) Applicant: Zu QIANG, Kirkland (CA)

(72) Inventor: Zu QIANG, Kirkland (CA)

(21) Appl. No.: 13/861,902

(22) Filed: Apr. 12, 2013

Related U.S. Application Data
(60) Provisional application No. 61/624,044, filed on Apr. 13, 2012.

(51) Int. Cl. H04W 74/00

(52) U.S. Cl. CPC H04W 74/004
USPC 370/254

(57) ABSTRACT

A 3GPP AAA server is able to instruct user equipment that it has been authenticated and authorized for access to a non-3GPP access network, but that access to the Evolved Packet Core has not been approved through the use of a modified Extensible Authentication Protocol message or an enhanced IPMS response. Upon receipt of such notification, the user equipment is able to configure itself to obtain data services through the access network, but will try to create EPC tunnels. This prevents the UE from being unable to connect to a local access network when the 3GPP AAA determines that it is unable to connect to the EPC.

### CROSS REFERENCE TO RELATED APPLICATIONS

This application claims the benefit of priority to U.S. Provisional Patent Application No. 61/624,044 filed Apr. 13, 2012, the contents of which are expressly incorporated herein by reference.

### TECHNICAL FIELD

This disclosure relates generally to mechanisms to enable user equipment to be offloaded from a cellular-based network to a broadband based data connection.

### BACKGROUND

In Release 8 of the 3rd Generation Partnership Project (3GPP) standards, a UE indicator, named IP mobility indicator (IPMS) was introduced. Dynamic IP Mobility Mode Selection (IPMS) consists of IP mobility management protocol that allows for selection between Network Based Mobility (NBM), Dual Stack Mobile IP version 6 (DSMIPv6) or Mobile IPv5 (MIPv4); and additionally allows for a decision on IP address preservation if NBM is selected.

Upon either initial attachment to a non-3GPP access network or handoff to a non-3GPP access network, the UE performs IPMS by providing an indication during network access authentication for EPC. For trusted access (access through a trusted non-3GPP access network), the indication is provided before an IP address is allocated to the UE. When using an un-trusted access network, the indication is provided during IKEv2 signalling for IPSec tunnel establishment with the ePDG.

When the UE provides an explicit indication for IPMS, then the network is required to provide an indication to the UE identifying the selected mobility management mechanism.

When the dynamic IP mobility mode selection is used and the UE does not receive an indication of a selected mobility protocol in response to providing an explicit indication, it is considered as an abnormal case and the UE may not get connectivity to the EPC.

FIG. 1 is a block diagram illustrating how the IPMS attribute is specified in TS 24.302. Attribute 50 can be broken into three fields based on octet grouping. In the first octet 50, the attribute type is specified (AT_IPMS_IND). In the second octet 54, a length of 1 is specified. In the final grouping of the third and fourth octets 56, a value is provided that indicates support for various protocols.

In 3GPP release 10, a new feature, named non-seamless WLAN offload, was added. Non-seamless WLAN offload is an optional capability that applies to a UE that can support WLAN radio access in addition to 3GPP radio access. It allows a UE to be directed to shift traffic from the 3GPP based Radio Access Network (RAN) to a Wi-Fi connection.

A UE supporting non-seamless WLAN offload may, while connected to WLAN access, route specific IP flows via the WLAN access without traversing the EPC. These IP flows are identified via user preferences, the Local Operating Environment Information defined in TS 23.261, and via policies set in the UE. The policies may be statically defined in the UE (such as by operator configuration), or could be dynamically set by the operator via the ANDSF. For such IP flows the UE uses the local IP address allocated by the WLAN access network and no IP address preservation is provided between WLAN and 3GPP accesses. To perform the non-seamless WLAN offload, the UE needs to acquire a local IP address through the WLAN access network. The UE is not required to connect to an evolved packet data gateway (ePDG).

In a scenario where the WLAN access is EPC connected, it is possible for a UE which supports seamless WLAN offload to perform seamless WLAN offload for some IP flows and non seamless WLAN offload for some other IP flows. The two different offload scenarios can be carried out simultaneously.

As currently defined in the above referenced standards, the IPMS indicator specifies one of three values: DSMIPv6, MIPv4 or Network based mobility (NBM). When the UE performs an initial attachment over a WLAN, 3GPP based access authentication may be performed. During the access authentication, the UE may send the IPMS to the 3GPP AAA. If EPC routing is allowed for the UE over the selected WLAN, the 3GPP AAA can respond with the IPMS. However, when EPC routing is not allowed for the UE over the selected WLAN, the 3GPP AAA is unable to respond to the UE IPMS request. According to TS 24.302, this situation is considered as an abnormal case in which the UE may stop the attachment procedure.

One skilled in the art will appreciate that 3GPP TS 24.302 and 3GPP TS 24.402 are publicly accessible documents that, as they exist at the time of filing, form background information known to those skilled in the art.

Therefore, it would be desirable to provide a system and method that obviate or mitigate the above described problems

### SUMMARY

It is an object of the present invention to obviate or mitigate at least one disadvantage of the prior art.

In an embodiment of the present invention, a 3GPP compliant AAA server transmits an indicator to the UE to inform the UE that EPC access is not permitted, but he access to the local network is accepted. The U, upon receipt of such an indicator, will process the message to determine the status of the indicator and will proceed with network attachment accordingly.

In a first aspect of the present invention, there is provided a method for configuring network access at a User Equipment node. The method is carried out at the UE and comprises the steps of transmitting, to a third generation partnership project, 3GPP, compliant authentication server, a request for access authentication for access to a 3GPP compliant packet core network through a non-3GPP access network and for access authentication for access to the non-3GPP access network; receiving a reply to the transmitted request rejecting the request for access to the packet core network; and configuring the UE to use the non 3GPP access network for a data connection.

In an embodiment of the first aspect of the present invention, the step of transmitting includes transmitting the request over the non-3GPP access network. In a further embodiment, the 3GPP compliant authentication server is a 3GPP Authentication, Authorization and Accounting, AAA, Server. In another embodiment, the step of transmitting includes transmitting the request with an IP Mobility Mode Selection, IPMS, indicator. In yet a further embodiment, the received reply further includes authorization and authentication for access to the non-3GPP access network. In another embodiment, the step of receiving includes receiving an Extensible Authentication Protocol, EAP, response and optionally the received reply further includes authorization and authentication for access to the non-3GPP access network and may include an IP Mobility Mode Selection response indicating authentication for local access only. In a further embodiment, the step of configuring includes configuring the UE to transmit data over the non-3GPP access network and optionally further includes the step of configuring the UE to use the non-3GPP access network without attempting a tunnel to the packet core network. In another embodiment, the transmitted request is specific to a single data flow from the UE. In another embodiment, the 3GPP core network is an Evolved Packet Core, EPC, network.

In a second aspect of the present invention, there is provided a user equipment node (UE). The UE comprises a first network interface, a processor and a memory. The first network interface allows for communication with a third generation partnership project (3GPP) compliant Authentication, Authorization and Accounting server. The memory stores program instructions. The processor executes the instructions stored in the memory, and upon doing so is capable of transmitting, to the 3GPP AAA server over the first network interface, a request for access authentication for access to a 3GPP compliant packet core network through a non-3GPP access network and for access authentication for access to the non-3GPP access network; and responsive to receipt of a reply to the transmitted request that rejects the request for access to the packet core network, configuring the UE to use the non 3GPP access network for a data connection.

In an embodiment of the second aspect of the present invention, the first network interface is a non-3GPP compliant interface for communicating over a non-3GPP compliant access network. In another embodiment, the first network interface is a 3GPP compliant radio access network interface, and further including a non-3GPP compliant interface for communicating over the non-3GPP compliant access network.

In a third aspect of the present invention, there is provided a method of authorizing a User Equipment node, UE, for access to a non-third generation partnership project, 3GPP, access network. The method is carried out at a 3GPP compliant Authentication, Authorization and Accounting, AAA, server and comprises the steps of: receiving from the UE a request for access authentication to a 3GPP compliant packet core network through the non-3GPP access network, and for access authentication to the non-3GPP access network; authorizing the UE for access to the non-3GPP access network; and transmitting approval to the UE for access to the non-3GPP access network but not the 3GPP core network.

In an embodiment of the third aspect of the present invention, the step of receiving includes receiving the request over the non-3GPP access network. In another embodiment of the third aspect, the received request includes an IP Mobility Mode Selection, IPMS, indicator. In a further embodiment, the method further includes the step of failing to authorize the UE for access to the 3GPP compliant packet core network through the non-3GPP access network in response to receiving the request. In a further embodiment, the step of transmitting includes transmitting the approval as an Extensible Authentication Protocol, EAP, response and optionally, the EAP response includes an IP Mobility Mode Selection response indicating authentication for local access only. In another embodiment, the approval includes an explicit rejection of the request for access to the packet core network. In a further embodiment, the received request is specific to a single data flow from the UE. In another embodiment, the 3GPP compliant packet core network is an Evolved Packet Core, EPC, network.

In a fourth aspect of the present invention, there is provided an Authentication, Authorization and Accounting, AAA, server for authorizing a User Equipment node, UE, to access a non-third generation partnership project, 3GPP, access network. The server comprises a network interface, a memory and a processor. The network interface allows for receiving request from, and transmitting responses to the UE. The memory stores program instructions. The processor, upon execution of the instructions stored in the memory performs the steps of responsive to receiving, over the network interface, a UE request for access authentication to a 3GPP compliant packet core network through the non-3GPP access network, and for access authentication to the non-3GPP access network, authorizing the UE for access to the non-3GPP access network; and transmitting towards the UE, through the network interface, approval for the UE to access the non-3GPP access network but not the 3GPP core network

Other aspects and features of the present invention will become apparent to those ordinarily skilled in the art upon review of the following description of specific embodiments of the invention in conjunction with the accompanying figures.

### BRIEF DESCRIPTION OF THE DRAWINGS

Embodiments of the present invention will now be described, by way of example only, with reference to the attached Figures, wherein:

FIG. 1 illustrates an IPMS attribute;

FIG. 2 illustrates an IPMS attribute (AT_IPMS_RES) that can be used by an AAA server to indicate to a UE that only local network access has been approved;

FIG. 3 illustrates a call flow diagram for message flows between a UE and a 3GPP AAA server;

FIG. 4 illustrates a call flow diagram for message flows between a UE and a 3GPP AAA server;

FIG. 5 illustrates a method carried out by a user equipment;

FIG. 6 is a block diagram illustrating a user equipment for carrying out the method of FIG. 5;

FIG. 7 illustrates a method carried out by a 3GPP AAA server; and

FIG. 8 is a block diagram illustrating a 3GPP AAA server for carrying out the method of FIG. 7.

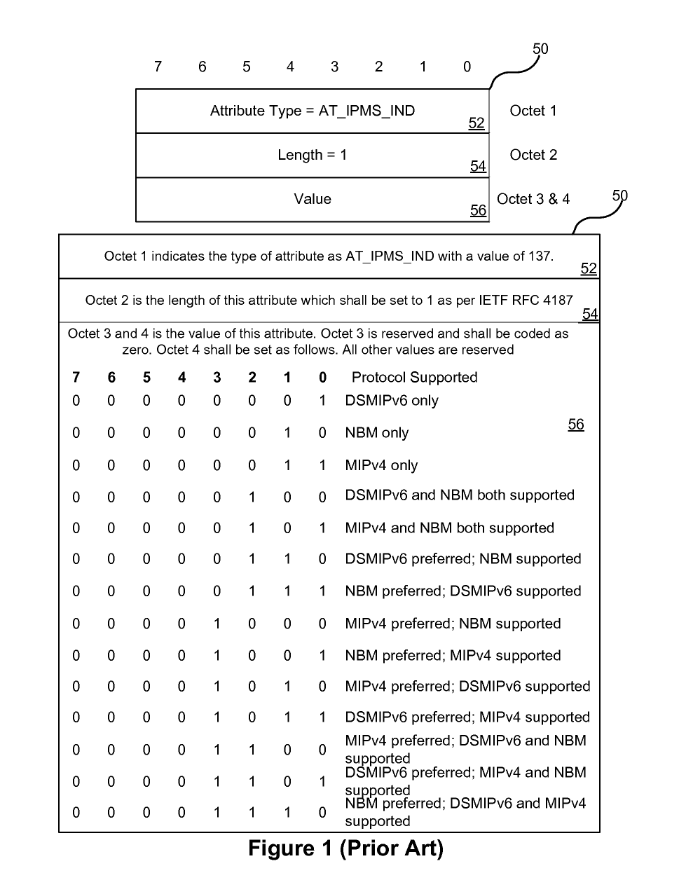

### DETAILED DESCRIPTION

The present invention is directed to a system and method for generating and recognizing new attributes in either the EAP or the IPMS response to indicate to the UE that local access network is permitted regardless of the status of the EPC access request.

Reference may be made below to specific elements, numbered in accordance with the attached figures. The discussion below should be taken to be exemplary in nature, and not as limiting of the scope of the present invention. The scope of the present invention is defined in the claims, and should not be considered as limited by the implementation details described below, which as one skilled in the art will appreciate, can be modified by replacing elements with equivalent functional elements.

As non-seamless offloading becomes more prevalent, situations in which the UE is authenticated for access to the local access network, but not to the 3GPP compliant EPC will increase in prevalence. As now laid out in 3GPP TS 24.302, this situation will result in the 3GPP AAA server (hereinafter referred to as a 3GPP AAA) being unable to respond to the UE's IPMS request, which will in turn result in the UE being unable to continue the attachment procedure. This is clearly problematic. To address this issue, the following embodiments are presented, in which the 3GPP AAA is able to instruct the UE that it can connect to the local access network, but cannot connect through the access network to the EPC. This configuration information can be used by the UE to establish a non-3GPP access network profile that allows the user to utilize a data connection between the UE and the non-3GPP access network.

In a first embodiment, upon receiving an IPMS request from the UE, over the non-3GPP access network, the 3GPP AAA responds with an extensible authentication protocol (EAP) message that provides one of the following options: “Request to access local network is accepted. But EPC access request is not accepted.” and “Request to access local network is accepted. EPC access request is accepted.”. One skilled in the art will appreciate that the particular names of these options can vary without departing from the scope of the present invention. This allows the 3GPP AAA to indicate to the UE that it has been authenticated for access to the local access network, but provides the flexibility of telling the UE whether it can access the EPC. The UE can then configure itself appropriately.

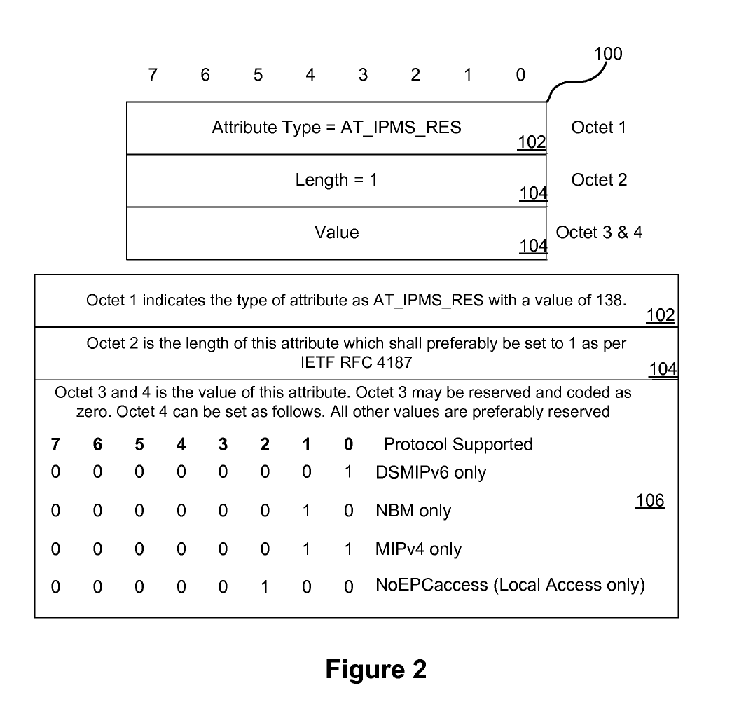

In a second embodiment, upon receiving an IPMS request from the UE, over the non-3GPP access network, the 3GPP AAA responds with an IPMS response containing a new attribute, such as that illustrated in FIG. 2, that indicates that only local access network access has been authorized. In response to receipt of such an indication, the UE is able to configure itself for local network access, but will not attempt set up EPC tunnels using mobility protocols. As illustrated, the exemplary IPMS attribute 100 again has three octet based groupings. In the first octet 100, the Attribute Type is specified, in this exemplary example it is specified as AT_IPMS_RES with a value of 138. In the second octet 104, the length is set and in the currently exemplary embodiment is set as 1. In the grouping of the third and fourth octet 106, various values are provided that can indicate to a receiving UE different configuration settings, including a setting for local access only which will be understood by those skilled in the art to mean that the UE has been authorized to connected only to the local network (e.g. the non-3GPP network) and has not been authorized to perform tunneling access to the EPC through the local access network.

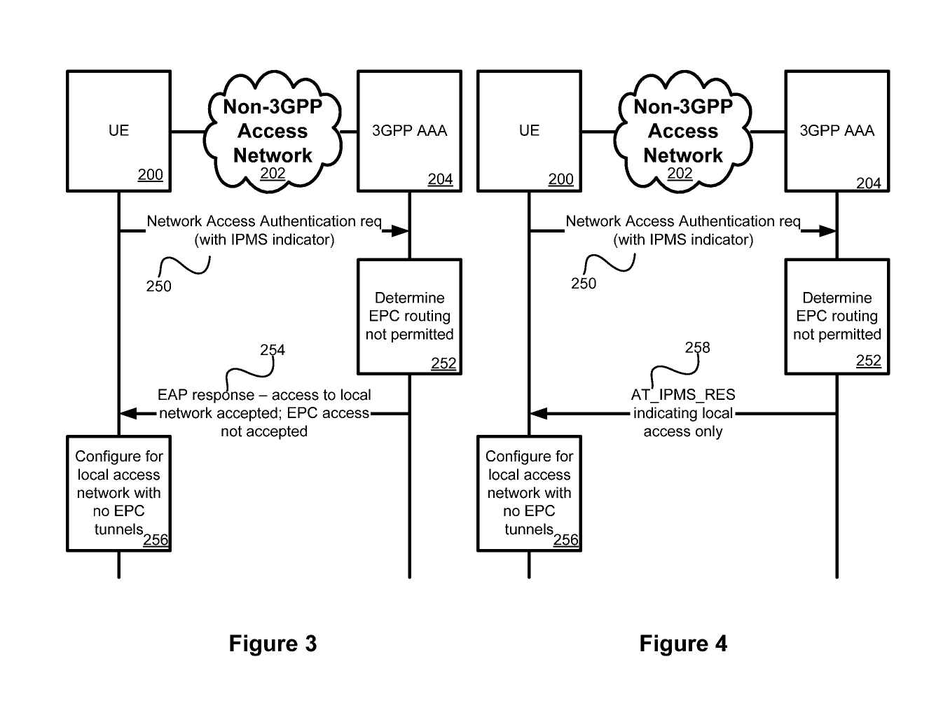

FIG. 3 illustrates a call flow between a UE 200 and the 3GPP AAA server 204. The process can be started by the UE 200 in response to receipt of an instruction to perform non-seamless offloading onto an available non-3GPP network 202, or it could be started by the UE 200 during an initialization process that is configured to attempt to establish network access through non-3GPP local access network 202. The UE 200 transmits a network access authentication request 250 to the 3GPP AAA server 204. This request preferably includes an IPMS indicator. The 3GPP AAA server 204 determines in step 252 that the UE 200 can be authorized and authenticated for access to the non-3GPP access network 202, but that EPC routing and access is not allowed. As a result of this determination, the 3GPP AAA server 204 sends an EAP response 254 that allows access to the local network 202, but indicates that EPC access is not accepted. The UE 200, upon receipt of this EAP response 254, configures itself for access to the local access network without EPC tunnels in step 256.

FIG. 4 illustrates an analogous call flow, with UE 200 issuing request 250, but in response to determining that EPC routing is not permitted in step 252, the 3GPP AAA server 204 sends an IPMS Response message (AT_IPMS_RES) 258 that indicates that the UE 200 is given only local access (e.g. access to the non-3GPP access network 202 but not to the EPC). The UE 200 can then configure itself for local access and will not attempt to create EPC tunnels through the non-3GPP access network in step 256.

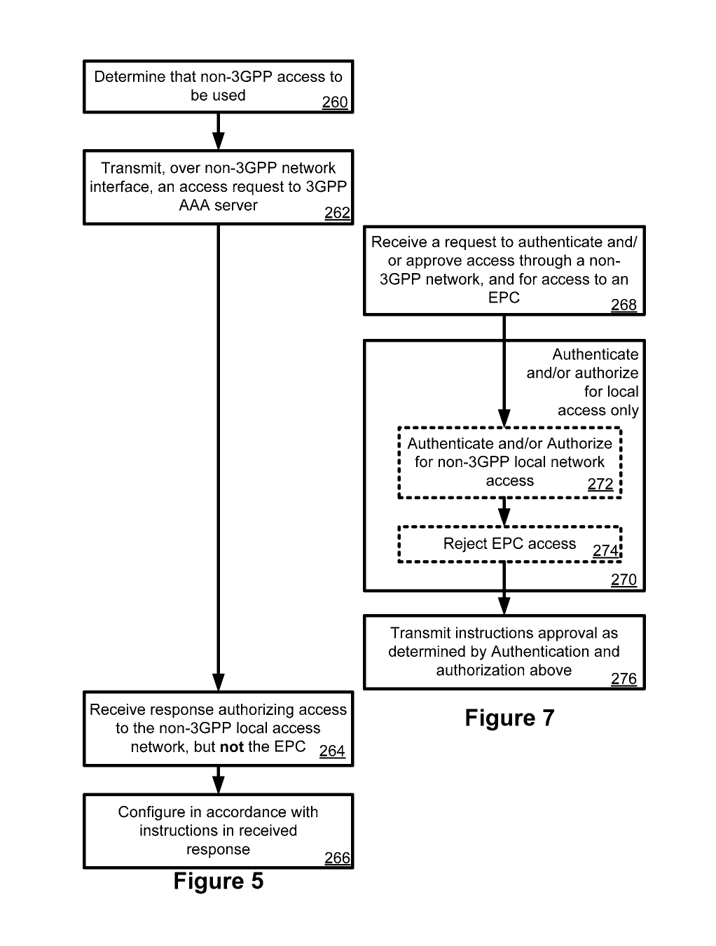

FIG. 5 illustrates an exemplary method for execution at the UE 200. The UE 200 determines that a non-3GPP access network is to be used in optional step 260. As noted above this may be in response to an instruction from the network, or it may be done in response to the detection of an available non-3GPP access network. Upon making this determination, the UE 200 transmits (through a non-3GPP network interface in some embodiments), a request addressed to the 3GPP AAA server in step 262. In one example the request transmitted in step 262 can be a request such as request 250 in FIGS. 3 and 4. This request, preferably containing an IPMS indicator, requests that the AAA server authenticate the UE 200, and authorize access both for the non-3GPP access network 202 and for the EPC. In response to transmission of this request, the UE 200 receives a response in step 264 that authorizes access to the non-GPP local access network. The response preferably explicitly indicates that access to the EPC is not approved. Examples of response received in step 264 can includes response 254 and response 258 as shown in FIGS. 3 and 4 respectively. The UE 200 uses the instructions contained in the received response to configure itself in step 266.

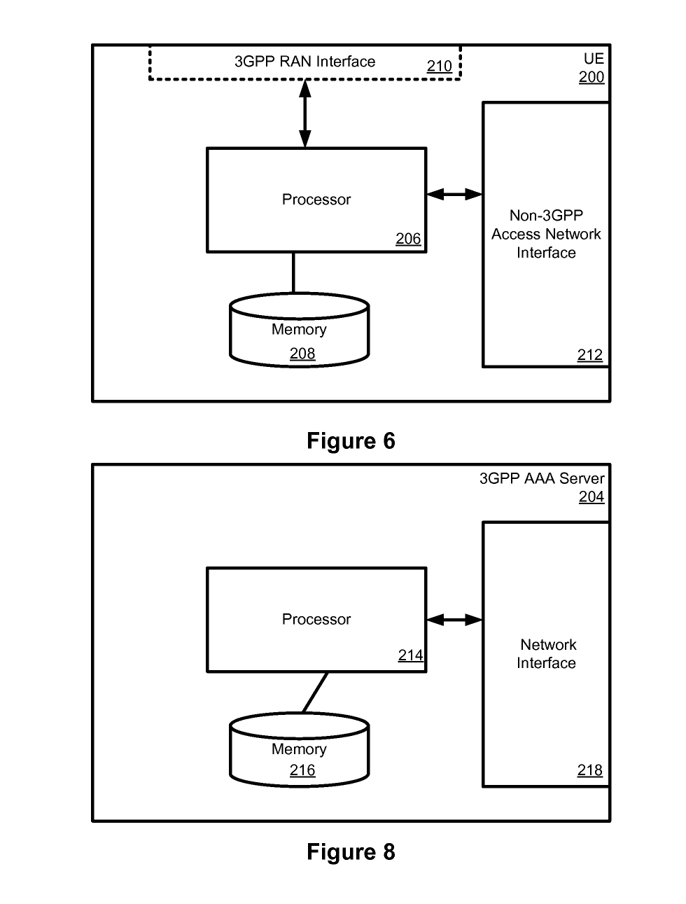

FIG. 6 is a block diagram illustrating a UE 200 for carrying out a method, such as the method of FIG. 5. The UE 200 contains a memory 208 accessible by the processor 206. The memory 208 stores a set of instructions that, when loaded by the processor 206, allow the processor 206 to carry out a method of requesting both access to a non-3GPP access network and access to the EPC through the non-3GPP access network. This request is transmitted to the 3GPP AAA through an interface, typically through the non-3GPP Access Network Interface 212. In some embodiments, an optional 3GPP Radio Access Network Interface 210 is also present. The request could be transmitted through the RAN interface 210, but would then preferably include information that identifies the non-3GPP access network to which the UE 200 is requesting authorization. Either the non-3GPP access network interface 212, or the optional 3GPP RAN interface 210, can be used to receive a response from the 3GPP AAA. This response is provided to the processor 206, which can determine that the response indicates that the UE 200 has been authorized for access in the non-3GPP access network, but has not been authorized for access to the EPC. The processor 206, upon receipt of this message can configure the operation of the UE 200 accordingly. One skilled in the art will appreciate that access to the non-3GPP access network and the EPC can differ according to different data streams, thus it may be possible for the UE 200 to have access to the non-3GPP access network but not the EPC for one data stream, and have access to both the non-3GPP access network and the EPC for another data stream. Other data streams could make use of the 3GPP RAN interface 210 as well.

FIG. 7 illustrates a method for execution at the 3GPP AAA server 204. The 3GPP AAA server 204 (or service if it is distributed across a plurality of nodes) receives a request for authentication and/or authorization for a UE in step 268. The request specifies that authentication and/or authorization is requested both for a non-3GPP local access network and for the evolved packet core (EPC). The 3GPP AAA 204 authenticates and/or authorizes the UE only for the non-3GPP local access network in step 270. This can be carried out, in some exemplary embodiments, by performing authentication and/or authorization for non-3GPP local access network in optional step 272, and then rejecting the request for EPC access in step 274. In response to the local access network approval, and EPC rejection, the 3GPP AAA 204 transmits instructions to the UE in step 276. One skilled in the art will appreciate that the rejection of EPC access can be done for any of a number of reasons including blanket rejection of access requests across the particular network, rejection of the UE on the particular network, and rejection of the UE on any non-3GPP access network. The 3GPP AAA 204 can provide approval on a per-UE basis, or on a per-UE based data flow basis. Those skilled in the art will appreciate that a number of different configurations and options can be provided as part of the process outlined above without departing from the scope of the present invention.

FIG. 8 is a block diagram illustrating a node (such as a 3GPP AAA Server 204) for carrying out the method of FIG. 7. A network interface 218 is used to receive requests and transmit responses under the control of a processor 214 that accesses a memory 216 containing instructions that allow the processor to carry out the method of FIG. 7.

Those skilled in the art will appreciate that the AAA server generates an EAP response to the request for authentication from the UE. In embodiments of the present invention, the EAP response includes an AT_IPMS_RES attribute that includes a flag such as NoEPCaccess. This flag indicates that access to the EPC is not permitted. Upon receipt of the EAP response including this indicator, the UE will preferably configure itself to not perform any IP mobility procedures for the PDN connection setup over EPC using the non-3GPP access network. It should be understood that the UE can continue to use the non-3GPP access network for non-EPC traffic (e.g. non-seamless WLAN offloading). The terms NoEPCaccess and Local Access Only may be used in a relatively interchangeable fashion.

One skilled in the art will appreciate that FIGS. 6 and 8 can be illustrated in other fashions including as functional elements to provide the same functionality. In the case of the UE 200, in addition to the network interfaces, a network selector can be used to determine which access network should be used, a request generator can generate the appropriate request for transmission to the 3GPP AAA 204, and a configuration engine can act upon the received response to configure the UE 200 as instructed. In the case of the 3GPP AAA server 204, one skilled in the art will appreciate that authentication engines and authorization engines can be implemented and called upon by functional elements receiving requests from the UE 200 through the network interface, and such functional elements can be used to generate and transmit, through the network interface, a set of instructions based upon results given by the authorization and authentication engines.

Embodiments of the invention may be represented as a software product stored in a machine-readable medium (also referred to as a computer-readable medium, a processor-readable medium, or a computer usable medium having a computer readable program code embodied therein). The machine-readable medium may be any suitable tangible medium including a magnetic, optical, or electrical storage medium including a diskette, compact disk read only memory (CD-ROM), digital versatile disc read only memory (DVD-ROM) memory device (volatile or non-volatile), or similar storage mechanism. The machine-readable medium may contain various sets of instructions, code sequences, configuration information, or other data, which, when executed, cause a processor to perform steps in a method according to an embodiment of the invention. Those of ordinary skill in the art will appreciate that other instructions and operations necessary to implement the described invention may also be stored on the machine-readable medium. Software running from the machine-readable medium may interface with circuitry to perform the described tasks.

In the above description, numerous acronyms were used, including
E-UTRAN: Evolved UMTS Terrestrial Radio Access Network
EPC: E-UTRAN Packet Core
EPS Evolved Packet System
LTE: Long Term Evolution
IKE: Internet Key Exchange protocol.
HeNB: Home eNB
MME: Mobility Management Entity
PCRF: Policy and Charging Rules Function
BPCF: Broadband Policy and Charging Function
BRAS: Broadband Remote Access Server
NAT: Network Address Translator
CP: IKE Configuration Payload
IETF: Internet Engineering Task Force
QoS: Quality of Service

The above-described embodiments of the present invention are intended to be examples only. Alterations, modifications and variations may be effected to the particular embodiments by those of skill in the art without departing from the scope of the invention, which is defined solely by the claims appended hereto.

What is claimed is:

1. A method for configuring network access at a User Equipment node, UE, the method carried out at the UE and comprising:
transmitting, to a third generation partnership project, 3GPP, compliant authentication server, a request for access authentication for access to a 3GPP compliant packet core network through a non-3GPP access network and for access authentication for access to the non-3GPP access network;
receiving a reply to the transmitted request rejecting the request for access to the packet core network; and
configuring the UE to use the non 3GPP access network for a data connection.

2. The method of claim 1 wherein the step of transmitting includes transmitting the request over the non-3GPP access network.

3. The method of claim 1 wherein the 3GPP compliant authentication server is a 3GPP Authentication, Authorization and Accounting, AAA, Server.

4. The method of claim 1 wherein the step of transmitting includes transmitting the request with an IP Mobility Mode Selection, IPMS, indicator.

5. The method of claim 1 wherein the received reply further includes authorization and authentication for access to the non-3GPP access network.

6. The method of claim 1 wherein the step of receiving includes receiving an Extensible Authentication Protocol, EAP, response.

7. The method of claim 6 wherein the received reply further includes authorization and authentication for access to the non-3GPP access network.

8. The method of claim 6 wherein the EAP response includes an IP Mobility Mode Selection response indicating authentication for local access only.

9. The method of claim 1 wherein the step of configuring includes configuring the UE to transmit data over the non-3GPP access network.

10. The method of claim 9 wherein the step of configuring further includes configuring the UE to use the non-3GPP access network without attempting a tunnel to the packet core network.

11. The method of claim 1 wherein the transmitted request is specific to a single data flow from the UE.

12. The method of claim 1 wherein the 3GPP core network is an Evolved Packet Core, EPC, network.

13. A user equipment node, UE, comprising:
a first network interface for communicating with a third generation partnership project, 3GPP, compliant Authentication, Authorization and Accounting server;
a processor for executing instructions; and
a memory for storing program instructions that when executed by the processor cause the processor to:
transmit, to the 3GPP AAA server over the first network interface, a request for access authentication for access to a 3GPP compliant packet core network through a non-3GPP access network and for access authentication for access to the non-3GPP access network; and
responsive to receipt of a reply to the transmitted request that rejects the request for access to the packet core network, configuring the UE to use the non 3GPP access network for a data connection.

14. The UE of claim 13 wherein the first network interface is a non-3GPP compliant interface for communicating over a non-3GPP compliant access network.

15. The UE of claim 13 wherein the first network interface is a 3GPP compliant radio access network interface, and further including a non-3GPP compliant interface for communicating over the non-3GPP compliant access network.

16. A method of authorizing a User Equipment node, UE, for access to a non-third generation partnership project, 3GPP, access network, the method carried out at a 3GPP compliant Authentication, Authorization and Accounting, AAA, server and comprising:
receiving from the UE a request for access authentication to a 3GPP compliant packet core network through the non-3GPP access network, and for access authentication to the non-3GPP access network;
authorizing the UE for access to the non-3GPP access network; and
transmitting approval to the UE for access to the non-3GPP access network but not the 3GPP core network.

17. The method of claim 16 wherein the step of receiving includes receiving the request over the non-3GPP access network.

18. The method of claim 16 wherein the received request includes an IP Mobility Mode Selection, IPMS, indicator.

19. The method of claim 16 further including the step of failing to authorize the UE for access to the 3GPP compliant packet core network through the non-3GPP access network in response to receiving the request.

20. The method of claim 16 wherein the step of transmitting includes transmitting the approval as an Extensible Authentication Protocol, EAP, response.

21. The method of claim 20 wherein the EAP response includes an IP Mobility Mode Selection response indicating authentication for local access only.

22. The method of claim 16 wherein the approval includes an explicit rejection of the request for access to the packet core network.

23. The method of claim 16 wherein the received request is specific to a single data flow from the UE.

24. The method of claim 16 wherein the 3GPP compliant packet core network is an Evolved Packet Core, EPC, network.

25. An Authentication, Authorization and Accounting, AAA, server for authorizing a User Equipment node, UE, to access a non-third generation partnership project, 3GPP, access network, the server comprising:
a network interface for receiving request from, and transmitting responses to the UE;
a processor for executing stored instructions; and
a memory for storing instructions that when executed by the processor cause the processor to:
responsive to receiving, over the network interface, a UE request for access authentication to a 3GPP compliant packet core network through the non-3GPP access network, and for access authentication to the non-3GPP access network, authorizing the UE for access to the non-3GPP access network; and
transmitting towards the UE, through the network interface, approval for the UE to access the non-3GPP access network but not the 3GPP core network
